(19) United States
(12) Patent Application Publication
(10) Pub. No.: US 2012/0124180 A1
(43) Pub. Date: May 17, 2012

(54) WEB-BASED COMPLIANCE TOOL

(75) Inventors: Edward J. Krauland, Bethesda, MD (US); Lucinda A. Low, Potomac, MD (US); Julia Court Ryan, Bethesda, MD (US); Shannon P. MacMichael, Springfield, VA (US); Robert L. Kovelman, Bell Canyon, CA (US); Paul M. McAdams, Los Angeles, CA (US)

(73) Assignee: INTERNAT LAW, LLC, Washington, DC (US)

(21) Appl. No.: 13/298,165

(22) Filed: Nov. 16, 2011

Related U.S. Application Data
(60) Provisional application No. 61/413,986, filed on Nov. 16, 2010.
(60) Provisional application No. 61/413,987, filed on Nov. 16, 2010.

(51) Int. Cl. G06F 15/16; H04L 9/32

(52) U.S. Cl. 709/219; 726/4

(57) ABSTRACT

A web-based compliance tool can be used to provide global companies and their employees with detailed information on local anti-corruption laws. In one embodiment, a method for providing a user with information on local laws in a plurality of jurisdictions to aid one or more persons in compliance therewith is provided on a web application. The information on the local laws may be developed by a legal professional in each jurisdiction in the form of a guide. A guide may include information on anti-corruption laws or information on laws affecting the hiring, retention, and termination of sales representatives. A guide may ensure compliance with local laws as well as, for example, the Foreign Corrupt Practices Act in the United States.

### CROSS-REFERENCE TO RELATED APPLICATIONS

This application claims priority to Provisional Application Nos. 61/413,986 and 61/413,987 filed on Nov. 16, 2010, which are hereby incorporated by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates to a web-based compliance tool designed to provide global companies and their employees with detailed information on local anti-corruption laws.

### BACKGROUND

A web application is an application that is accessed over a network such as the Internet or an intranet. It can be a computer software application that is hosted in a browser-controlled environment or coded in a browser-supported language and reliant on a common web browser to render the application accessible and executable. Web applications are popular due to the ubiquity of web browsers, and the convenience of using a web browser as a client. Common web applications include webmail, online retail sales, online databases, and other functions.

Local law is an increasingly important element of global anti-corruption. Securing the necessary information about local laws in different jurisdictions may be a challenge, let alone finding a single location to obtain such information. Accordingly, there remains a need for improvements in the area of presenting detailed, organized information on local laws in a single location.

### SUMMARY

Briefly, and in general terms, various embodiments are directed to a web-based compliance tool. In some embodiments, a method for providing a user with information on local laws in a plurality of jurisdictions to aid one or more persons in compliance therewith is provided. On a web application, one or more guides for each jurisdiction are provided. Each guide may be developed by a legal professional in each jurisdiction. The one or more guides may include information on anti-corruption laws or information on laws affecting the hiring, retention, and termination of sales representatives. A subscriber may subscribe for access to the information for a price. The subscriber may be an individual user of a company with one or more users. The subscriber may be able to identify one or more groups of users. Different groups of users may have different access capabilities. Identification information from a user under a subscription may be received and verified. Upon verification that the identification information corresponds to a user under a subscription, the user is permitted to access information available under the subscription.

The foregoing summary does not encompass the claimed invention in its entirety, nor are the embodiments intended to be limiting. Rather, the embodiments are provided as mere examples.

### BRIEF DESCRIPTION OF THE DRAWING

FIG. 1 is a block diagram illustrating an embodiment of a system involving a web-based compliance tool.

FIG. 2 illustrates one embodiment of a simplified view of a home page associated with the web-based compliance tool in FIG. 1.

FIG. 3 illustrates one embodiment of a simplified view of a login page associated with the web-based compliance tool in FIG. 1.

FIG. 4 illustrates one embodiment of a simplified view of a landing page associated with the web-based compliance tool in FIG. 1.

FIG. 5 illustrates one embodiment of a simplified view of a reporting page corresponding to a first country associated with the web-based compliance tool in FIG. 1.

FIG. 6 illustrates one embodiment of a simplified view of a reporting page corresponding to a second country associated with the web-based compliance tool in FIG. 1.

FIG. 7 illustrates one embodiment of a simplified view of a reporting page corresponding to a third country associated with the web-based compliance tool in FIG. 1.

FIG. 8 depicts one embodiment of a system enabling download of content from the web-based compliance tool to a client device.

### DETAILED DESCRIPTION

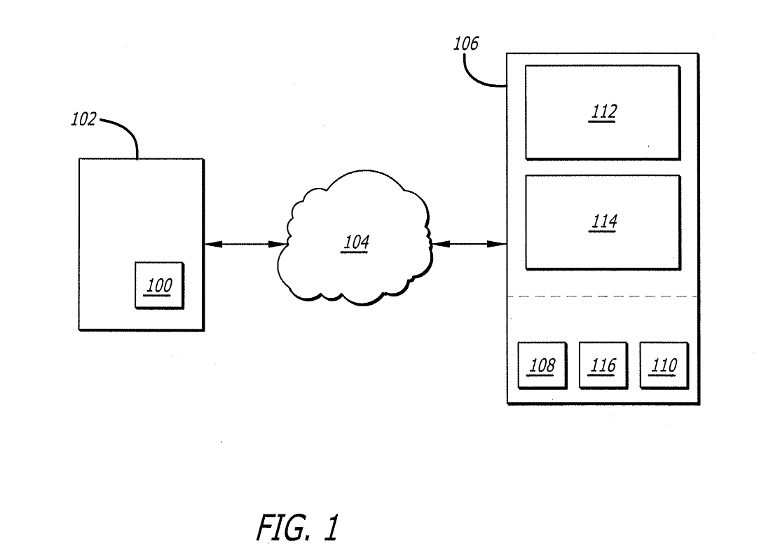

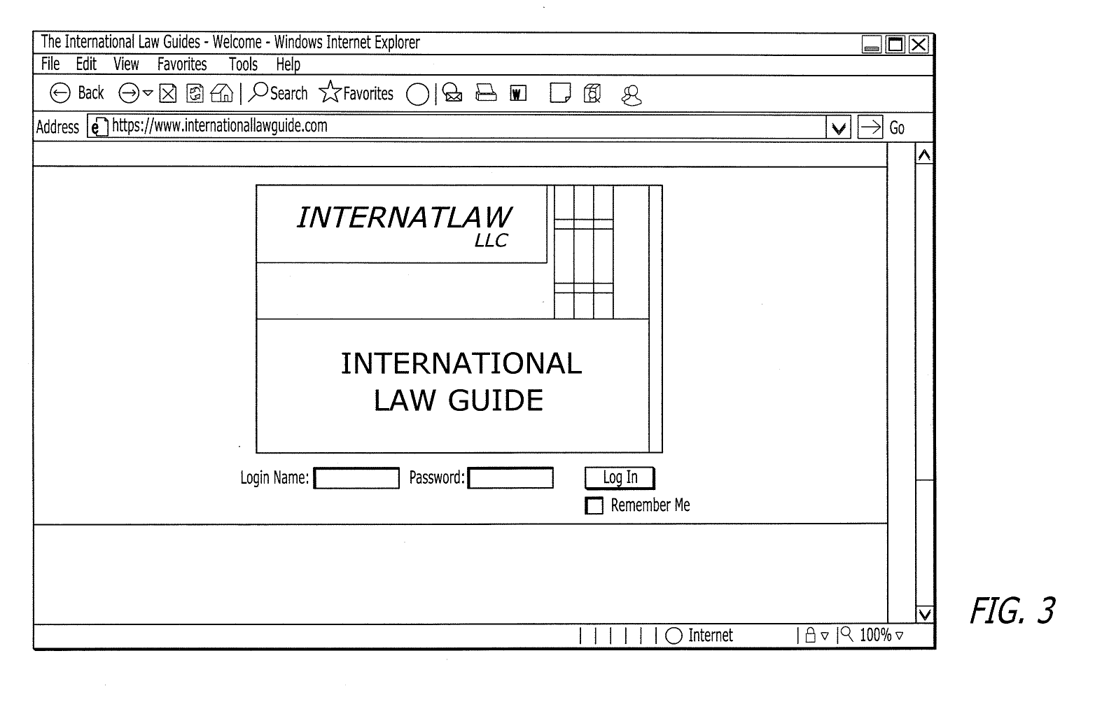

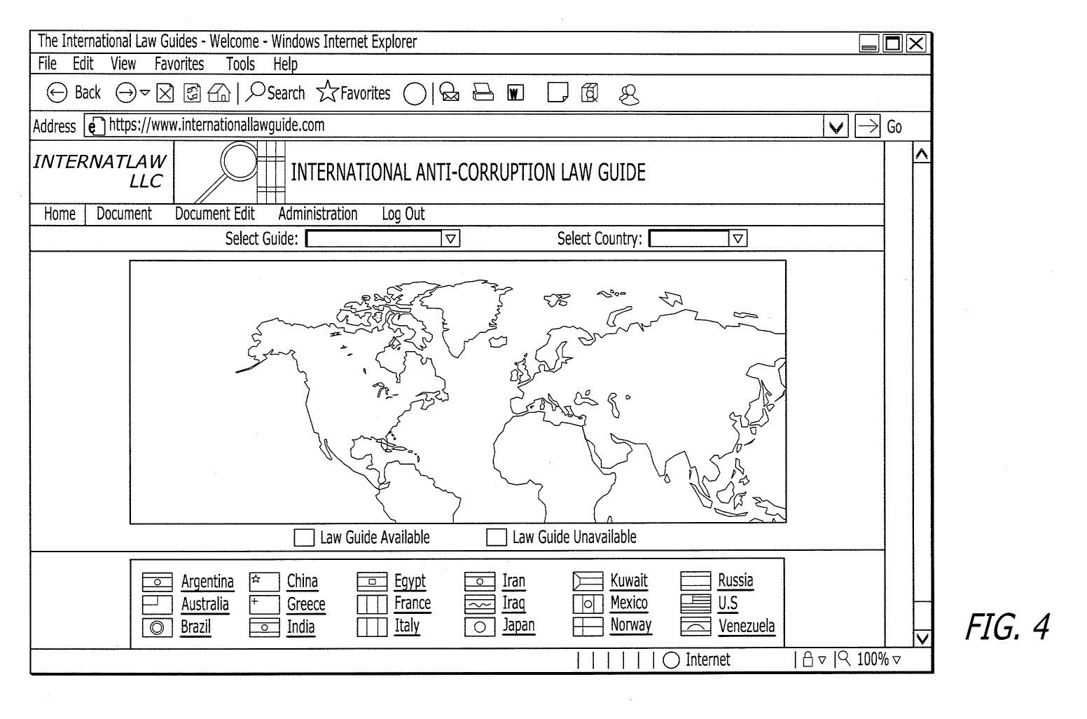

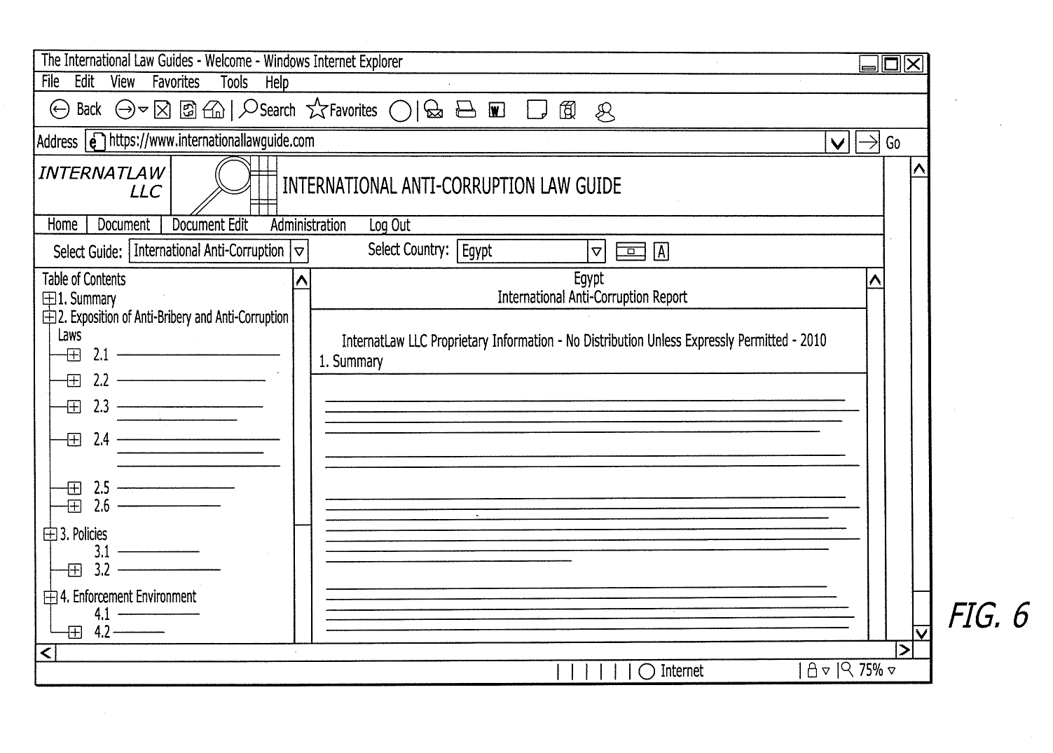

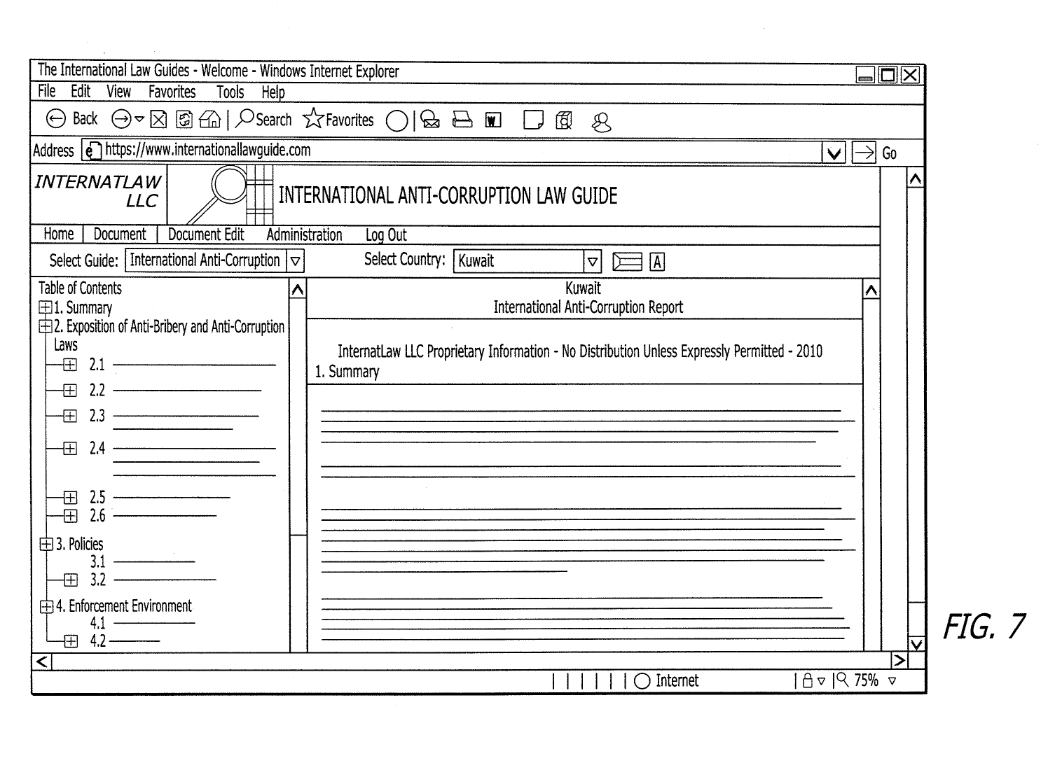

Referring now to the drawings, wherein like reference numerals denote like or corresponding parts throughout the drawings and, more particularly to FIGS. 1-8, there are shown various embodiments of a web-based compliance tool.

As shown in FIG. 1, the web-based compliance tool 100 may be an application that resides on a server 102 accessible over a network 104. The web-based compliance tool 100 may include static and/or dynamic information. A client device 106 may operatively connect to the network 104, such as the internet or an intranet. The client device 106 includes a processor 108, a memory 110, a display 112, and one or more user input devices 114. In one embodiment, the client device 106 may be a hand held device. In some embodiments, the client device 106 may include a mobile phone, computer, tablet, personal data assistant, eReader, or other device that may operatively connect to a network. The processor 108 may execute a plurality of software instructions to run a web browser 116 on the display 112 of the client device 106. In some embodiments, the web browser 116 is hosted and run on an external system to the client device 106, for example, in a cloud computing system. The web browser 116 enables the client device 106 to communicate with the server 102. A user may instruct the client device 106, using one or more user input devices 114, to request data from the server 102 in the form of, for example, a web page. In this way, a user may interact with the web-based compliance tool 100 on a server 102 through a web browser 116 over a network 104.

The server 102 may be a standalone web server that processes requests for data from the client device 106 using a plurality of internal processors and circuits. Upon receiving a request for information, the server 102 executes a plurality of software instructions to fetch and transmit the requested data to the client device 106 for viewing on the display 112. In other embodiments, the server 102 may include a web server and an application server. In these embodiments, the web server may resolve requests for data associated with static information corresponding to the web-based compliance tool 100, and the application server may resolve requests for data associated with dynamic information corresponding to the web-based compliance tool 100.

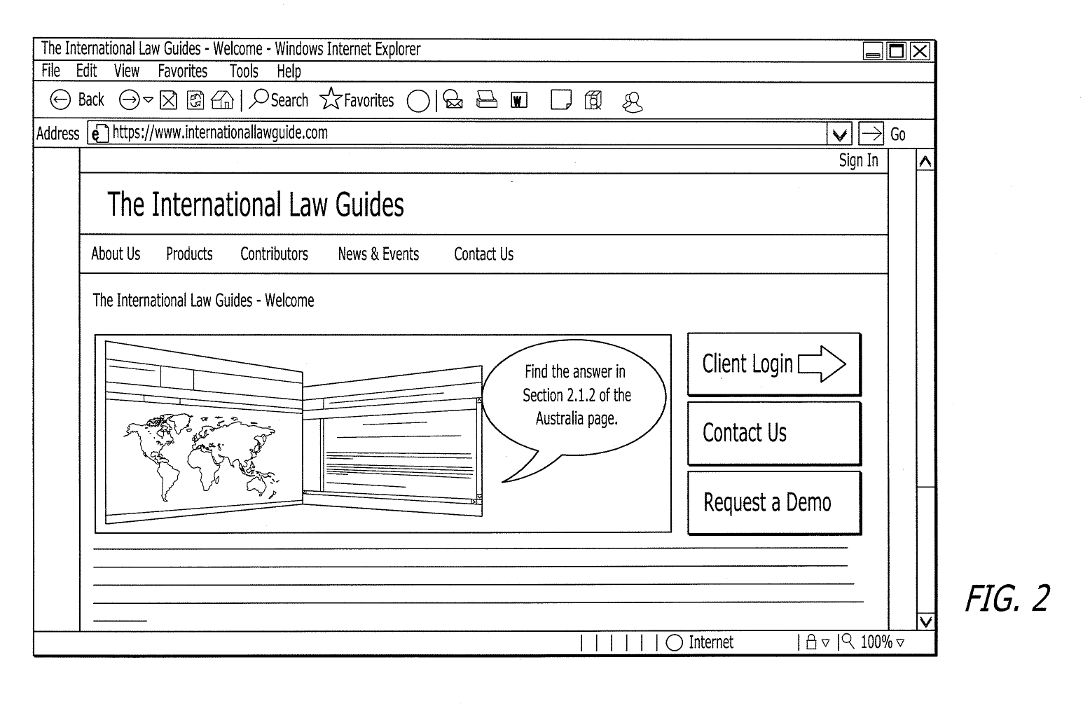

As shown in FIGS. 2-4, the web-based compliance tool 100 that provides international law guides is designed to present subscribers with detailed information on local anti-corruption laws. In some embodiments, information on local anti-corruption laws may be relevant for compliance with the Foreign Corrupt Practices Act (“FCPA”). The web-based compliance tool 100 may also present subscribers with information on laws affecting the hiring, retention, and termination of sales representatives in countries around the world. Subscribers may include individuals or business entities (e.g., companies and their employees) that pay for the right to access the international law guides.

In some embodiments, the subscription price to the international law guides may be based on: (1) the number of users having access to the guides under a subscription; (2) the number of logins logged on a daily, monthly, or annual basis; (3) the type or size of the business entity; (4) the types of individuals having access to the guides (e.g., attorneys, sales representatives, consultants, and the like); (5) the number of usernames and passwords provided; (6) the amount of time spent reviewing information on one or more of the guides; (7) any searches conducted by one or more users; (8) where a user is accessing one or more guides (e.g., country, state, province, time zone, legal jurisdiction, and the like); (9) a flat fee (e.g., monthly or annually); (10) whether the one or more guides are being accessed before or after predefined criteria (e.g., initiation of an FCPA lawsuit); (11) the number of guides the subscriber is subscribing to; or (12) any combination thereof.

For example, different price points may correspond to 1, 10, 25, 50, 100, or more users under a single subscription. Additionally or alternatively, the subscription may be based on a pay-as-you-access system that may bill the subscriber at the end of each month or other billing cycle. For example, each access to one or more guides may cost the subscriber a flat “per access fee,” which may be in addition to an overall subscription fee. This pricing scheme may be advantageous for smaller companies having less need to access the one or more guides when compared to larger companies. As yet another example, companies can subscribe to one or more guides (e.g., the International Anti-Corruption Law Guide and/or the International Representatives Law Guide) for a three-year term where subscribers may have unlimited access to a password-protected website for an unlimited number of employees. In such embodiments, the company may be provided with a unique username and password to access the website or a link to the website can appear on a company's intranet page.

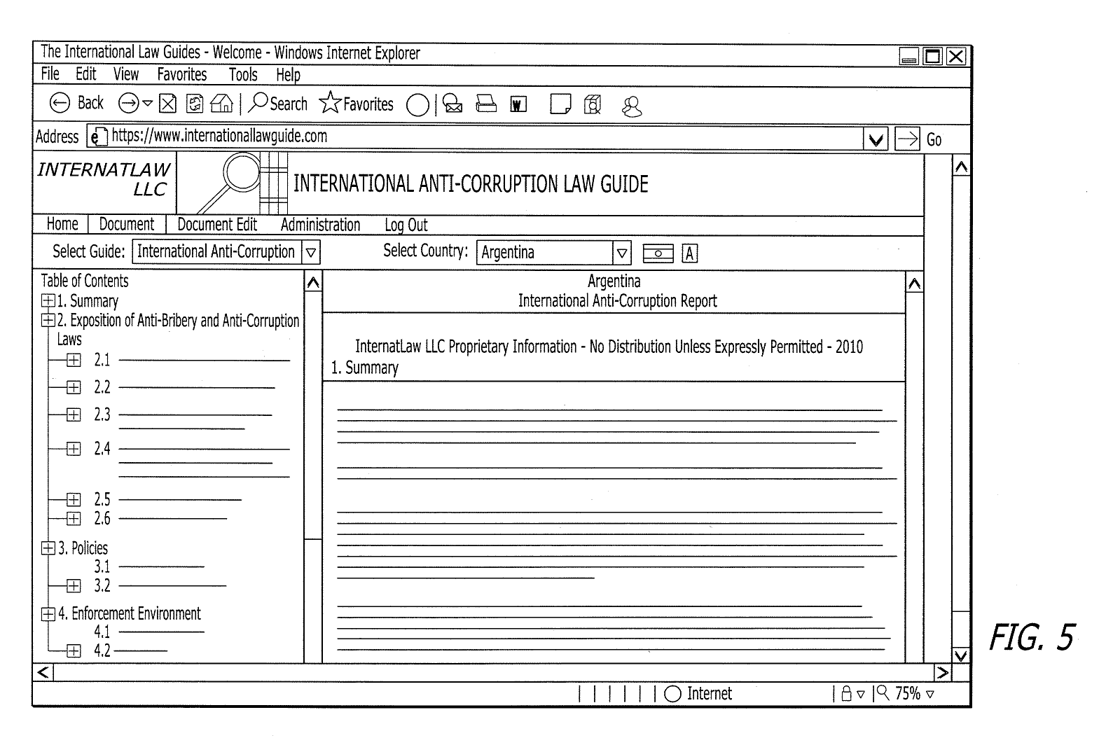

Each country guide may be developed by a legal professional, such as an attorney, in the local jurisdiction with the requisite experience. A template may be used to ensure uniformity of the components within each country guide so that a user may quickly find similar information in two or more different country guides. In some embodiments, the legal professionals responsible for drafting these guides may be paid a fee based on the amount of work, whether the guide was previously drafted, whether the guide is being updated, and the like. In other embodiments, the legal professionals drafting these guides may be paid based on a percentage of the fees paid by the one or more subscribers that have access to the guides. As shown in FIGS. 5-7, each guide may be written in English and carefully vetted for clarity and scope. In other embodiments, each guide may be written in one or more languages. In yet other embodiments, a user under a subscription may request that one or more guides be translated from a first language to a second language.

The guides may be posted online in a simple, consistent, and user-friendly format. A user under a subscription may be required to input a username and password to login or otherwise be provided access to the online material. In some embodiments, a single username and password may be used by all users under a single subscription. In other embodiments, a unique username and password is provided or created by each user under a subscription. In such embodiments, logging or keeping track of who is accessing information online is readily maintained. In this regard, access of the compliance information by members of a sales force (or other travelling personnel) may be appropriately monitored by a subscriber, such as a company, to ensure that company rules are being followed (e.g., employees must check one or more guides on a weekly or monthly basis). In addition, keeping track of each user enables different price points for different types of users (e.g., attorneys and non-attorneys) as well as different types of access. For example, subscribers may prefer that a first type of user only be privy to certain information whereas a second type of user is not privy to this information. In one embodiment, attorneys employed by a subscriber may have access to the web-based compliance tool while other employees may not have access. This may be configured by the subscriber (e.g., preference settings) or inherent in the system (e.g., usernames and passwords may only be provided to attorneys).

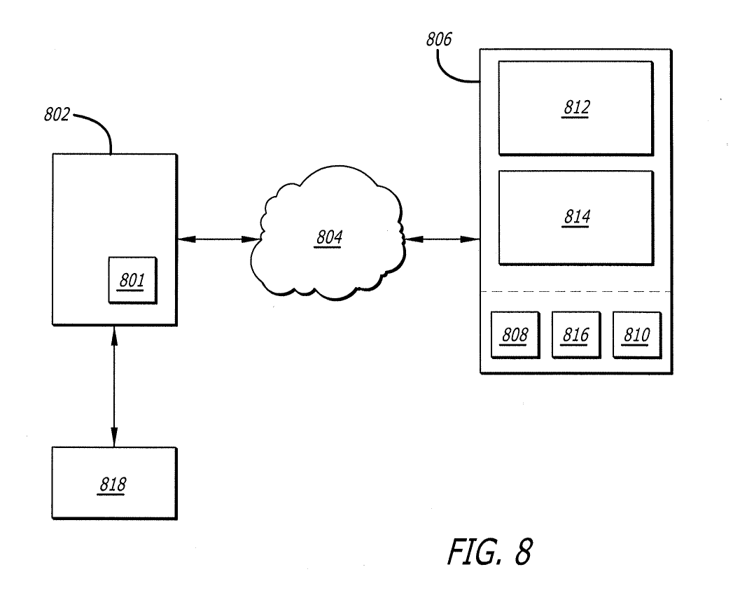

A system 800 for enabling download of content from the web-based compliance tool 801 to a client device 806 is shown in FIG. 8. The web-based compliance tool 801 may be an application that resides on a server 802 accessible over a network 804. The web-based compliance tool 800 may include static and/or dynamic information. A handheld client device 806 may operatively connect to the network 804, such as the internet or an intranet. The client device 806 includes a processor 808, a memory 810, a display 812, and one or more user input devices 814. In some embodiments, the client device 806 may include a mobile phone, computer, tablet, personal data assistant, eReader, or other device that may operatively connect to a network. The processor 808 may execute a plurality of software instructions to run a web browser 816 and present it on the display 812 of the client device 806. In some embodiments, the web browser 816 is hosted and run on an external system to the client device 806, for example, in a cloud computing system. The web browser 816 enables the client device 806 to communicate with the server 802. A user may instruct the client device 806, using one or more user input devices 814, to request data from the server 802 in the form of, for example, a web page. In this way, a user may interact with the web-based compliance tool 801 on a server 802 through a web browser 816 over a network 804.

The guides may be downloadable to the client device 806 from a database 818 in communication with the server 802 over the network 804 so that lack of internet or intranet access does not interfere with a user's ability to access the guides. The database 818 may be internal or external to the server 802.

The downloadable content may or may not mirror the format of the online guides and may utilize an application to mimic the functionality of the web application. In some embodiments, the downloaded guides may present a warning to the user that only online material is guaranteed to be up-to-date, and reliance on downloaded material beyond a predefined time frame is ill-advised. For example, the warning may be presented after 1 day, 3 days, a week, or a month has passed since the material has been downloaded. This time period may be configured by the subscriber to ensure its users are appropriately warned under a time frame determined by the subscriber. In some embodiments, the warning may populate the display 812 associated with the client device 806 when the downloaded content is accessed on the client device by the user. Also in some embodiments, the server 802 may ping or otherwise transmit a message to the client device 806 informing the user that the guides have been updated or have been changed in some way. Each country guide may be updated on a periodic basis, such as daily, weekly, monthly, or annually. In this regard, upon information being updated on one or more guides, each user may receive a text message, email, or a message in another format to inform him or her of such an update. The user may be required to register their phone number or email address to enable such functionality. This may be accomplished through a user preference screen online.

The system shown in FIG. 8 may also function as a location alert system. In some embodiments, the client device 806 is a GPS-enabled device, such as a user's mobile phone. The GPS-enabled device 806 in such embodiments may periodically transmit GPS data to the server 802. The server 802 may then determine whether the GPS data requires one or more guides be transmitted over the communication network 804 to the GPS-enabled client device 806 for viewing by the user.

In other embodiments, the GPS-enabled client device 806 may automatically request information from the server 802 based on the GPS data switching from a first jurisdiction to a second jurisdiction. For example, the GPS-enabled client device 806 may, using the processor 808, execute a plurality of software instructions that analyze GPS data received by or otherwise on the client device to ascertain whether the GPS data falls within a particular jurisdiction. The server 802 may transmit the requested information (e.g., information related to the second jurisdiction) to the GPS-enabled device 806 via email, text message (e.g., SMS or MMS), or other messenger-transmitting medium. Additionally or alternatively, the GPS-enabled device 806 may initiate the web browser and automatically bring the user to the requested information online. The requested information may serve as an alert and/or a reminder for the user to check the local laws associated with the second jurisdiction. The requested information may include a link to the web-based compliance tool 801. In some embodiments, one or more guides associated with the second jurisdiction may automatically be sent in an email or downloaded directly to the GPS-enabled device. For example, a user that travels with a GPS-enabled device 806 from the United States to China may receive an email containing one or more guides associated with China. The one or more guides may be embedded in the text of the body of the email or as attachments.

In some embodiments, the client device 806 may in fact not be configured with any location tracking technology. Instead, the user of the client device 806 may transmit a message (e.g., email or text message) to a recipient (e.g., the server 802) upon entering a new jurisdiction. For example, a user that travels from the United States to China may text the word “China” to a predefined number that the server 802 is configured to receive data from or is otherwise associated with. The server 802 may receive this text and email one or more guides associated with China based on the determination that the user transmitted “China” to the server. Thus, a user may be tracked, either automatically or manually, to ensure compliance with one or more guides when travelling.

The web-based compliance tool shown in FIGS. 1-8 may issue a certificate (e.g., electronic certificate) to a user that documents the user has in fact reviewed one or more specific guides. The certificate may be used for auditing purposes to ensure employees are in fact reviewing the available information provided by the web-based compliance tool as set forth herein. In some embodiments, a subscriber (e.g., company) may require a user to provide such a certificate prior to travelling to a particular jurisdiction (e.g., country). In some embodiments, the web-based compliance tool stores information related to the user, the guides accessed, and the time accessed for auditing purposes for employee-compliance purposes without issuing a certificate.

The web-based compliance tool shown in FIGS. 1-8 may include currency exchange information and/or a currency converter to help ensure currency values are accurate. Currency exchange information may include a link to a website providing currency exchange information and/or a currency converter. The currency converter may automatically or manually convert monetary values in one or more guides. For example, a first country guide may include currency values in the currency associated with the first country. The currency values number may be complemented by approximate U.S. dollar information in, for example, parenthesis next to the currency values associated with the first country. This parenthetical U.S. dollar information may be updated every minute, hour, day, week, or month. Similarly, non-U.S. dollar information (e.g., first country currency values) may also be updated in this way. In this regard, users under a subscription may readily ascertain two approximately equivalent currency values without having to input information to do so.

In one embodiment, International Anti-Corruption Law Guides provide a country-by-country overview of local laws, regulations, policies, and practices that apply to the range of payment issues companies encounter when doing business abroad, including facilitation payments, product marketing, transportation, accommodations, meals, entertainment, gifts, contributions, and business courtesies.

Designed to provide practical guidance for businesses operating around the world, the International Anti-Corruption Law Guides may identify and summarize anti-bribery and anti-corruption laws, regulations, and policies for gifts, business courtesies, marketing, and facilitating or other payments and in-kind benefits provided to members of the government and private sector. The Guides may highlight key elements of these laws, including information on bases of jurisdiction, civil and criminal liability, persons subject to jurisdiction (e.g., specifically addressing the liability of legal persons), and penalties. The Guides may also provide case law and information about the enforcement environment relevant to the applicable law in the jurisdiction. In some embodiments, the Guides offer specific and practical guidance regarding application of laws, regulations, and policies to business operations and circumstances. The Guides may provide specific guidance regarding the use of facilitation payments. In some embodiments, the Guides may provide information regarding gifts, meals, accommodations, transportation, hospitality, and entertainment, as well as charitable contributions and political donations. The Guides may also provide information regarding applicable monetary limitations, required approvals or notifications, explanation of any “reasonableness” standard, and permissibility of spouse/family participation. The Guides may include any combination of the identified information to provide practical guidance for businesses operating around the world.

In one embodiment, 1, 10, 30, 50, or more country guides may be available. A single subscription fee may be associated with each country or a single fee may include all available guides for each country.

In addition to the International Anti-Corruption Law Guides, the web-based compliance tool also includes an International Representatives Law Guides that contain a country-by-country overview of the local laws, regulations, practices, and government policies that apply to the engagement, management, compensation, and termination of sales representatives, sales agents, and consultants.

Specifically created for companies that sell products and services through a sales agent, representative, or consultant, the International Representatives Law Guides may provide information for each country regarding the permissibility of retaining representatives/consultants for sales involving military and/or commercial products to the government, as well as commercial products outside the government context. The Guides may provide information regarding law and government policy regarding the permissibility of the payment of commissions, as well as any limitations on permissible amounts or percentages. The Guides may also provide information on the typical treatment of representatives/consultants and commissions in government tender documents. In some embodiments, the Guides may include information on citizenship, residency, and/or incorporation requirements specific to representatives/consultants. The Guides may provide information regarding registration requirements for representatives/consultants and/or contracts, and any associated requirements or approvals. The Guides may also include information on laws regulating the termination of representatives/consultants, including any applicable indemnities. In some embodiments, the Guides may provide information regarding restrictions on using former military or civilian government employees as representatives/consultants. The Guides may also include information on the extent to which local law will give effect to contractual provisions on governing law and dispute resolution mechanisms and the extent to which mandatory local law may supersede a contract. The Guides may include any combination of the identified information with respect to pertaining to international representatives/consultants.

Those of ordinary skill in the art will appreciate that one or more circuits and/or software may be used to implement the methods and processes described herein. Circuits refers to any circuit, whether integrated or external to a processing unit. Software refers to code or instructions executable by a processing unit to achieve the desired result. This software may be stored locally on a processing unit or stored remotely and accessed over a communication network.

The various embodiments and examples described above are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims.

In some embodiments, the web-based compliance tool may include application software code, such as the code provided below. The software code provided below is a non-limiting example of software code associated with the web-based compliance tool. In other embodiments, different software code from than that provided below may be associated with the web-based compliance tool.

Option Explicit; On
Option Strict On
<Serializable( )> Public Class Application

Inherits SJLibraryBase
Private _strName As String
Private _strDescription As String
Private _objUsers As Users
Private _strHeaderImageURL As String
Private _strAttributel As String
Private _strAttribute2 As String
Private _strAttribute3 As String
Private _strAttribute4 As String
Private _strAvailableColor As String
Private _strUnAvailableColor As String
Private _strBackGroundColor As String
Private _strHoverColor As String
Private _objDocuments As Documents
Public ReadOnly Property Documents( ) As Documents

Get

If _objDocuments Is Nothing Then

_objDocuments = New Documents (Me.CurrentUserID, Me.ApplicationID)

End if

Return objDocuments
End Get

End Property
Protected Overrides Sub InitializeVaribles( )

_strName = String.Empty
_strDescription = String.Empty
_strHeaderTmageURL = “00000000-0000-0000-0000-000000000000”
_strAttributel = “00000000-0000-0000-0000-000000000000”
_strAttribute2 = “00000000-0000-0000-0000-000000000000”
_strAttribute3 = “00000000-0000-0000-0000-000000000000”
_strAttribute4 = “00000000-0000-0000-0000-000000000000”

End Sub
Public ReadOnly Property Users( ) As Users

Get

If _objUsers Is Nothing Then

_objUsers = New Users(Me.CurrentUserID, Me.ApplicationID)

End if
Return _objUsers
End Get

End Property
Protected Overrides ReadOnly Property DeleteStoreProcedureName( ) As String

Get

Return “DeleteApplication”

End Get

End Property
Protected Overrides ReadOnly Property InsertStoreProcedureName( ) As String

Get

Return “InsertApplication”

End Get

End Property
Protected Overrides ReadOnly Property UpdateStoreProcedureName( ) As String

Get

Return “UpdateApplication”

End Get

End Property
Protected Overrides ReadOnly Property ParameterValues( ) As ArrayList

Get

Dim al As New ArrayList
al.Add(New Sq1Client.SqlParameter(“Name”, Me.Name))
al.Add(New Sq1ClieptSqlParameter(“Description”,Me.Description))
al.Add(New Sq1Client.Sq1Parameter(“HeaderImageURL”, Me.HeaderImageURL))
al.Add(New Sq1Client.ScliParameter(“Attributel”, Me.Attributel))
al.Add(New Sq1Client.SqlParameter(“Attribute2”, Me.Attribute2))
al.Add(New Sq1Client.SqlParameter(“Attribute3, Me.Attribute3))
al.Add(New Sq1Client.ScalParameter(“Attribute4”, Me.Attribute4))
al.Add(New Sq1Client.Sq1Parameter(“AvailableColor”, Me.AvailableColor))
al.Add(New Sq1Client.Sq1Parameter(“UnAvailabieColor”, Me.UnAvailableColor))
al.Add(New Sq1,Client.Sq1Parameter(“HoverColor”, Me.HoverCo1or))
al.Add(New Sq1Client.SqlParameter(“BackGroundColor”, Me.BackGroundColor))
Return al

End Get

End Property
Protected Overrides ReadOnly Property DataTableName( ) As String

Get

Return “Application”

End Get

End Property
Public ReadOnly Property ApplicationID( ) As String

Get

Return Me. ID

End Get

End Property
Public Property Name( ) As String

Get

Return _strName

End Get
Set (ByVa1 value As String)

if (_strName < > Value) Then

_strName = value
MyBase.MakeDirty( )

End If

End Set

End Property
Public Property Description( ) As String

Get

Return _strDescription

End Get
Set (ByVa1 value As String)

If (_strDescription < > value) Then

_strDescription = value
MyBase.MakeDirty( )

End if

End Set

End Property
Public Property HoverColor( ) As String

Get

Return _strHover-Color

End Get
Set (ByVal value As String)

If (_strHoverColor < > value) Then

_strHoverColor = value
MyBase.MakeDirty( )

End If

End Set

End Property
Public Property.UnAvailableColor ( ) As String

Get

Return _strUnAvailableColor

End Get
Set (ByVal value As String)

if (_strUnAvailableColor < > value) Then

_strUnAvailableColor = value
MyBase.MakeDirty( )

End If

End Set

End Property
Public Property AvailableColor( ) As String

Get

Return _strAvailableColor

End Get
Set (ByVal value As String)

If (_strAvailableColor < > value) Then

_strAvailableColor = value
MyBase.MakeDirty( )

End If

End Set

End Property
Public Property BackGroundColor( ) As String

Get

Return _strBackGroundColor

End Get.
Set (ByVal value As String)

If (_strBackGroundColor < > value) Then

_strBackGroundColor = value
MyBase.MakeDirty( )

End If

End Set

End Property
Public Property HeaderImageURL( ) As String

Get

Return _strHeaderImageURL

End Get
Set (ByVal value As String)

If (_strHeaderImageURL < > value) Then

_strHeaderImageURL = value
MyBase.MakeDirty( )

End If

End Set

End Property
Public Property Attributel( ) As String

Get

Return _strAttributel

End Get
Set (ByVal value As String)

if (_strAttributel < > value) Then

_strAttributel = value
MyBase.MakeDirty( )

End If

End Set

End Property
Public Property Attribute2( ) As String

Get

Return _strAttribute2

End Get
Set (ByVal value As String)

If (_strAttribute2 < > value) Then

_strAttribute2 = value
MyBase.MakeDirty( )

End If

End Set

End Property
Public Property Attribute3( ) As String

Get

Return _strAttribute3

End Get
Set (ByVal value As String.)

If (_strAttribute3 < > value) Then

_strAttribute3 = value
MyBase.MakeDirty( )

End if

End Set

End Property
Public Property Attribute4( ) As String

Get

Return _strAttribute4

End Get
Set (ByVal value As String)

If (_strAttribute4 < > value) Then

_strAttribute4 = value
MyBase.MakeDirty( )

End If

End Set

End Property
Friend Overloads Overrides Sub Load (ByVal strCurrentUserID As String, ByVal

objDataRow As System.Data.DataRow)

MyBase.LoadBaseValues(strCurrentUserID, objDataRow)
If Not IsDBNull(objDataRow(“Name”)) Then

_strName = CStr(objDataRow (“Name”).ToString( ))

Else

_strName = String.Empty

End If
_strBackGroundColor = objDataRow(“BackGroundColor”).ToString( )
_strUnAvailableColor = objDataRow (“UnAvailableColor”).ToString( )
_strAvailableColor = objDataRow(“AvailableColor”).ToString( )
_strHoverColor = objDataRow(“HoverColor”).ToString( )
If Not IsDBNull (objDataRow (“Description”)) Then

_strDescription = CStr (objDataRow(“Description”).ToString( ))

Else

_strDescription = String.Empty

End If
If Not IsDBNull (objDataRow (“HeaderImageURL”)) Then

_strHeaderImageURL = CStr (objDataRow(“HeaderImageURL”). ToString( ))

Else

_strHeaderImageURI, = String.Empty

End If
If Not IsDBNull (objDataRow (“Attributel”)) Then

_strAttributel = CStr (objDataRow (“Attributel”).To String( ))

Else

_strAttributel = String.Empty

End If
If Not IsDBNull (objDataRow (“Attribute2”)) Then

_strAttribute2 = CStr (objDataRow (“Attribute2”).ToString( ))

Else

_strAttribute2 = String.Empty

End If
If Not IsDBNull (objDataRow (“Attribute3”)) Then

_strAttribute3 = CStr (objDataRow (“Attribute3”).ToString( ))

Else

_strAttribute3 = String.Empty

End If
If Not IsDBNull (objDataRow (“Attribute4”)) Then

_strAttribute4 = CStr (objDataRow (“Attribute4”).ToString( ))

Else

_strAttribute4 = String.Empty

End If

End Sub
Public Function GetMapXML (ByVal obj] Documents As Documents, Optional ByVal

blnMakeClickable As Boolean = True) As String

Dim objMapItems As New SJLibrary.MapItems (Me.CurrentUseriD)
Dim strXML As New System.Text.StringBuilder ( )
‘Initialize <map> element
strXML.AppendFormat (“<map showLabels=‘0’ useSNameInLabels=‘0’

showToolTip=‘1’ includeNameInLabels=‘0’ includeValueInLabels=‘0’
borderColor=‘FFFFFF’ fillAlpha=‘80’ showBevel=‘1” legendPosition=‘None’
hoverOnEmpty=‘O’ hoverColor=‘{0}’ bgColor=‘{1}’>”, Me.HoverColor,
Me.BackGroundColor)

strXML.Append (“<data>“)
For intIndex As Integer = 0 To objMapItems.Count − 1

strXML.AppendFormat(“<entityid=‘ {O}’ showLabel=‘0’

useSNameInToolTip=‘1’”, objMapItems(intIndex).InternalID)

If binMakeClickable Then

strXML.AppendFormat(“ value=“{1}1”,

objMapItems(intIndex),InternalID, intIndex.ToString( ))

End if
Dim intIndexOfDocument As Integer
Dim strDocumentName As String =

objMapItems(intIndex).Name.Replace(“&”, “”).Replace(“’”,””)

Select Case strDocumentName

Case “UnitedArabEmirates”

strDocumentName = “United Arab Emirates”

Case “Korea (north)”

strDocumentName = “North Korea”

Case “Korea (south)”

strDocumentName = “South. Korea”

End Select
intIndexOfDocument =

Me.Documents.IndexOfByName(objMapItems(intIndex).Name)

If intIndexOfDocument > −1 Then

strXML.AppendFormat (“displayValue = ‘{0} - Law Guide

Available’ color = ‘{1}’”, strDocumentName, Me.AvailableColor)

If objDocuments Is Nothing OrElse

objDocuments.DoesExists(Me.Documents(intIndexOfDocument).DocumentID) Then

If blnMakeClickable Then

strXML.AppendFormat(“link=‘JavaScript:OpenDocument({01};’”,

intIndexOfDocument)

End If

strXML.AppendFormat(“ toolText=’” & strDocumentName & “’”,)
Else

If blnMakeClickable Then

strXML.Append(“link=‘JavaScript:NoAccess( );’”)

End If
strXML.AppendFormat (“ toolText’=”& strDocumentName &

“- Not Subscribed’”)

End If

Else

strXML.AppendFormat (“displayValue” = ‘{0} - Law Guide

Not Available’ color= ‘{1}’”, strDocumentName, Me,UnAvailableColor)

strXML.AppendFormat (“ toolText=’” & strDocumentName & “’ ”)

End If
strXML.Append(“ />”)

Next
‘close data element
strXML.Append (“</data>”)
‘close map element
strXML.Append (“</map>“)
Return strXML.ToString ( )

End Function

Public. Sub New (ByVal strCurrentUserID As String)

MyBase.New(strCurrentUserID)

End Sub
Public Sub New(ByVal strCurrentUserID As String, ByVal
strApplicationID As String)

MyBase.New(strCurrentUserID, strApplicationID)

End Sub
Public Sub New ( )
End Sub

End Class

What is claimed:

1. A method for providing a user with information on local laws in a plurality of jurisdictions to aid in compliance therewith, the method comprising:
providing, on a web application, one or more guides for each jurisdiction that are developed by a legal professional in each jurisdiction, wherein the one or more guides include information on anti-corruption laws or information on laws affecting the hiring, retention, and termination of sales representatives;
subscribing, under a subscription, a subscriber to the one or more guides for one or more jurisdictions for a price, wherein a subscriber is an individual user or a company with a one or more users;
enabling the subscriber to identify one or more groups of users;
receiving identification information from a user under the subscription;
verifying the identification information corresponds to the user under the subscription; and
permitting the user to access the one or more guides associated with one or more jurisdictions on a client device associated with a user under the subscription.

2. The method of claim 1, wherein the web application includes an internet or intranet portal.

3. The method of claim 1, wherein jurisdiction is a country.

4. The method of claim 1, wherein the legal professional is an attorney licensed to practice law.

5. The method of claim 1, wherein sales representatives includes consultants.

6. The method of claim 1, further comprising downloading or transmitting content to the client device.

7. The method of claim 6, wherein downloading or transmitting content includes downloading or transmitting content directly to a memory associated with the client device, sending a text message, or sending an email.

8. The method of claim 6, wherein content includes the information on anti-corruption laws or the information on laws affecting the hiring, retention, and termination of sales representatives.

9. The method of claim 6, wherein content includes a warning that the downloaded or transmitted content is not guaranteed to be up-to-date or a recommendation that the user check information on the web application for up-to-date information.

10. The method of claim 6, wherein the client device is GPS-enabled.

11. The method of claim 10, wherein downloading or transmitting content is based on location data associated with the GPS-enabled client device.

12. The method of claim 10, wherein downloading or transmitting content is based on a determination that the GPS-enabled client device has left a first jurisdiction and has entered a second jurisdiction.

13. The method of claim 12, wherein the downloaded or transmitted content corresponds to information associated with the second jurisdiction.

14. The method of claim 12, wherein the downloaded or transmitted content includes an alert that the user has entered the second jurisdiction or a reminder for the user to check information associated with the second jurisdiction to ensure compliance therewith.

15. The method of claim 1, further comprising transmitting a jurisdictional message from the client device.

16. The method of claim 15, further comprising receiving information corresponding to a jurisdiction in the jurisdictional message on the client device.

17. The method of claim 1, further comprising providing currency exchange information.

18. The method of claim 1, further comprising providing a currency converter that automatically or manually converts monetary values in the one or more guides.

19. The method of claim 1, further comprising enabling the subscriber to configure one or more groups of users having different types of access to the information on local laws, wherein types of access include no access and full access.

20. The method of claim 1, further comprising downloading or transmitting a message to the client device that indicates information available on the web application has been updated or changed since content has been downloaded or transmitted.

21. The method of claim 1, further comprising issuing a certificate to the user for each of the one or more guides reviewed by the user.

22. The method of claim 1, further comprising storing information identifying one or more guides accessed by the user.

23. The method of claim 1, further comprising storing information identifying when the user accessed one or more guides.

24. The method of claim 1, wherein the information on anti-corruption laws includes identifying and summarizing anti-bribery and anti-corruption laws, regulations, or policies for gifts, business courtesies, marketing, and facilitating other payments and in-kind benefits provided to members of a government and private sector.

25. The method of claim 1, wherein the information on anti-corruption laws includes highlighting key elements associated with anti-corruption laws, including information on bases of jurisdiction, civil and criminal liability, persons subject to jurisdiction, or penalties.

26. The method of claim 1, wherein the information on anti-corruption laws includes providing case law and information about enforcement relevant to applicable law in one or more of the jurisdictions.

27. The method of claim 1, wherein the information on anti-corruption laws includes offering specific and practical guidance regarding application of laws, regulations, or policies to business operations and circumstances.

28. The method of claim 1, wherein the information on anti-corruption laws includes providing specific guidance regarding use of facilitation payments.

29. The method of claim 1, wherein the information on anti-corruption laws includes providing information regarding gifts, meals, accommodations, transportation, hospitality, entertainment, charitable contributions, or political donations.

30. The method of claim 1, wherein the information on anti-corruption laws includes providing information regarding applicable monetary limitations, required approvals, or notifications, explanation of any reasonableness standard, or permissibility of spouse/family participation.

31. The method of claim 1, wherein information on laws affecting the hiring, retention, and termination of sales representatives includes providing information regarding permissibility of retaining representatives for sales involving military or commercial products to a government or sales to a non-government entity.

32. The method of claim 1, wherein information on laws affecting the hiring, retention, and termination of sales representatives includes providing information regarding law and government policy regarding permissibility of payment of commissions or limitations on permissible amounts or percentages.

33. The method of claim 1, wherein information on laws affecting the hiring, retention, and termination of sales representatives includes providing information regarding citizenship, residency, or incorporation requirements specific to representatives.

34. The method of claim 1, wherein information on laws affecting the hiring, retention, and termination of sales representatives includes providing information regarding registration requirements for representatives or contracts.

35. The method of claim 1, wherein information on laws affecting the hiring, retention, and termination of sales representatives includes providing information regarding laws regulating termination of representatives including applicable indemnities.

36. The method of claim 1, wherein information on laws affecting the hiring, retention, and termination of sales representatives includes providing information regarding restrictions on using former military or civilian government employees as representatives.

37. The method of claim 1, wherein information on laws affecting the hiring, retention, and termination of sales representatives includes providing information regarding extent to which local law will give effect to contractual provisions on governing law and dispute resolution mechanisms.

38. The method of claim 1, wherein information on laws affecting the hiring, retention, and termination of sales representatives includes providing information regarding extent to which mandatory local law may supersede a contract.
